(19) United States
(12) Patent Application Publication
(10) Pub. No.: US 2014/0067551 A1
(43) Pub. Date: Mar. 6, 2014

(54) METHOD AND SYSTEM FOR PROVIDING AN ONLINE MARKER INDICATIVE OF ADVERTISEMENT SPEND

(71) Applicant: DEX ONE DIGITAL, INC., Santa Monica, CA (US)

(72) Inventor: Rene Christian Schaub, Los Angeles, CA (US)

(73) Assignee: DEX ONE DIGITAL, INC., Santa Monica, CA (US)

(21) Appl. No.: 13/707,069

(22) Filed: Dec. 6, 2012

Related U.S. Application Data
(60) Provisional application No. 61/694,396, filed on Aug. 29, 2012.

(51) Int. Cl. G06Q 30/02

(52) U.S. Cl. CPC G06Q 30/0273
USPC 705/14.69

(57) ABSTRACT

A method and system for adding a marker to an online digital advertisement that is indicative of the advertiser's ad spend relative to the advertiser's peer advertisers. A computer implemented method for providing a User Interface Element (UI element) as a marker with an online digital advertisement indicative of advertisement spend. Receiving at a computer system an input indicative of a selection of a UI element associated with data indicative of advertisement spend. Providing a UI element tool responsive to receiving the selection of the UI element and where the activated area presents a graphic indicative of advertisement spend

### CROSS REFERENCE

This application claims priority to and the benefit of U.S. Provisional Patent Application Ser. No. 61/694,396, filed on 29 Aug. 2012 and entitled METHOD AND SYSTEM FOR PROVIDING AN ONLINE MARKER INDICATIVE OF ADVERTISEMENT SPEND, which is hereby incorporated herein by reference in its entirety.

### BACKGROUND OF INVENTION

1. Field of Invention

This invention relates generally to managing internet based marketing campaigns and, more particularly, to performance based online digital advertisement and online indicators of advertisement spend for such campaigns.

2. Background Art

The Pay-per-click (PPC) advertising model and other similar online digital advertisement revenue models revolutionized direct marketing to consumers on the internet. Today PPC is fundamental to the monetization of search-engine results and fundamental to driving qualified traffic to websites. E-commerce sites and large brand sites were the first to adopt PPC as a marketing strategy while small and medium sized businesses have been slow to move in that direction. A small business values direct customer interaction through a phone call or email, and regards a click to a website as only the first step in the sale conversion funnel. Measuring the conversion from clicks to calls as well as understanding the conversion of calls to customers realized is necessary to properly manage the PPC campaign and ensure positive return-on-advertiser-spend (ROAS). This places the burden on the small business owner to collect data and run complex analytical calculations on a regular basis. If the calculations are flawed because of lack of data or scarcity of quality data, the business owner may overspend for traffic that does not deliver ROAS or underspend and not receive any traffic.

The primary challenge with PPC for a small business is that the business owner is interested in leads, such as phone calls, emails, filled out lead forms requesting services, and less interested in website clicks. The pay-per-click model has been modified to other models, for example, the pay-per-call (PPCalI) model by Ingenio where a business sets up a campaign similar to a PPC campaign but is bidding for calls not clicks. While these models may be more attractive to the small business owner, these models do not solve their problem of providing visibility into the call volume (or lead volume) that will be delivered and the effective cost-per-lead incurred. In addition, leads are delivered in unpredictable bursts that can overwhelm a small business owner's ability to process them and results in waste.

One concern of business owners in managing the bidding or auction process is for online digital advertisement for on-line keyword search engines. Businesses often will bid on keywords for search engine providers such that there advertisement or website is at the top of the list of search results when a user enters a search query using certain keywords. The problem, is managing the bidding process to be cost effective and achieve the greatest result for the advertisement spend. To address this concern businesses often hire marketing consulting firms to manage the bidding process. The consulting firms manage the pay-per-click ad campaigns and the bidding process in order to achieve the businesses' click-through realization goals. The consulting firms often use rule based algorithms to establish and maintain keyword bidding. However, managing the bidding process has its difficulties, particularly if the consulting firm is managing multiple businesses that are very similar.

One difficulty in managing advertisement campaigns is managing the perception of the viewers of the various campaigns. A perception issue for viewers of the content presented within an advertisement campaign may be their lack of visibility into what the advertiser's investment is for the campaign. For example, in a typical paper copy business directory containing categorical alphabetical listings of business names, addresses, telephone numbers and related information and advertising, a viewer has some visibility into the advertisement spend based on the size of the ad and the content. A user of such a paper copy directory can usually discern the relative investments made for each of the individual listings that are made by the various businesses based on the size or the percentage of the page that a given listing/advertisement occupies. The larger the percentage of the page occupied by the listing typically reflects the larger spend for the listing and advertisement. A further indicator of spend can be the use of color and/or graphics in the paper ad as compared to a simple text only ad.

A user may use the association of advertisement spend with advertisement print size as a gauge to measure the likely size of the business, its credibility, and/or quality of services or products provided. In other words the viewer may perceive that a higher ad spend reflects on the size of the advertiser and/or the quality of services of the advertiser. However, in the online digital advertising arena, this visibility or insight cannot reliably be discerned because an advertiser may not make a long term commitment to an online advertising campaign as they would with paper print.

For example, in the online digital advertisement arena, an advertiser may only commit to selectively displaying their ad at a given time of the day, week, month or year, however a viewer may by happen stance view the selectively displayed ad, but would have no indication that the ad is not consistently displayed. For example, a viewer may for the only time in a three year span enter a search for local plumbers in the area, and by happen stance, because of the day of the month the viewer is conducting the search, a dynamic specially placed ad for “NO NAME” plumbers appears, but the viewer doesn't realize that this ad is only displayed one day of the month from 8:00 AM to Noon. A remedy to eliminate this false indicator or false perception on the part of the viewer is needed in the online digital advertising arena.

### BRIEF SUMMARY OF INVENTION

The technology is a method and system for adding a marker or other indicator to an online digital advertisement that is indicative of the advertiser's ad spend or the advertisers overall ad spend budget relative to the advertiser's peer advertisers (other advertisers in the same business space). One implementation of the technology is a computer implemented method for providing a User Interface Element (UI element) as a marker with an online digital advertisement indicative of advertisement spend or overall ad spend budget. The method can include the steps of receiving at a computer system an input indicative of a selection of a UI element associated with data indicative of advertisement spend; and providing a UI element tool having display attributes for displaying on a user interface an activated area associated with the UI element tool responsive to receiving the selection of the UI element and where the activated area presents a graphic indicative of advertisement spend.

Another implementation of the technology is a computer implemented method for providing a UI element as a marker with an online digital advertisement indicative of advertisement spend. This implementation of the method can include displaying on a user interface at a computer system a UI element associated with data indicative of advertisement spend; receiving an input at the computer system indicative of a selection of the UI element associated with data indicative of advertisement spend; and displaying a UI element tool on a user interface having an activated area associated with the UI element tool responsive to receiving the selection of the UI element and where the activated area presents a graphic indicative of advertisement spend.

Another implementation of the technology can be a computer system for controlling an activated mouse-over area of a user interface. This implementation can include a computer having a memory and one or more processors and one or more programs, stored in the memory and executed by the one or more processors, where the one or more programs can include, instructions for receiving at a computer system an input indicative of a selection of a UI element associated with data indicative of advertisement spend; and instructions for providing a UI element tool having display attributes for displaying on a user interface an activated area associated with the UI element tool responsive to receiving the selection of the UI element and where the activated area presents a graphic indicative of advertisement spend based on the data associated with the UI element.

Yet another implementation can be a computer system for controlling an activated mouse-over area of a user interface. This implementation can include a computer having a memory and one or more processors and one or more programs, stored in the memory and executed by the one or more processors, where the one or more programs include, instructions for displaying on a user interface at a computer system a UI element associated with data indicative of advertisement spend. The program can also can include instructions for receiving an input at the computer system indicative of a selection of the UI element associated with data indicative of advertisement spend; and for displaying a UI element tool on a user interface having an activated area associated with the UI element tool responsive to receiving the selection of the UI element and where the activated area presents a graphic indicative of advertisement spend based on the data associated with the UI element.

For online digital advertisement, for example on the internet, the only place where an advertiser can differentiate their ad with a snazzier ad is in the Display area. Those are mostly for branding. However for the vast majority of relevant ad space text ads are used that all share the same format. The one problem with that is that as a viewer, there is no way of knowing how much money an advertiser is paying for his exposure. This is true in general, because online listings can change every day or every second, so just because a viewer sees an advertiser as the first listing at any given moment doesn't mean the same ad will show first tomorrow even if the same search is being conducted using the same search tool. Furthermore it is never clear whether an advertiser shows up high because of better user experience and therefore the search engine provider ranks the listing higher or because the advertiser paid a lot of money. It may be that the advertiser only paid for the ad to show high in a certain hour, or it could be that the ad most of the time shows lower, or similar scenario.

The above can be contrasted with the typical paper-based listings. If a viewer sees a full page ad for a plumber, that plumber ad will still be there tomorrow with the full page ad for likely the next 12 months, so a viewer knows that the advertiser is paying a lot of money for this as compared to an advertiser that has a two-line entry in the same listing. Not only does the full page ad provide more information and catches the eye of the viewer, but also when comparing advertisers, the viewer has a gauge of the advertising stake of each business.

The present technology described and claimed herein adds a marker on each digital ad that gives an indication to the viewer of how much the advertiser is spending relative to his peers. In one implementation of the technology the method and system can provide a graphic illustration of an advertiser's advertisement spend (actual monetization yield based on actual realized click-throughs and total billings from various publishers). In another embodiment, the method and system can provide an illustration of an advertiser's advertisement spend “budget” regardless of how much of the actual budget has been spent (monetized based on actual click throughs and billings). The terms “advertiser spend”, “advertising spend” and “advertisement spend” are intended herein to include within their meaning actual monetization and/or budget.

The marker can be in each digital advertiser listing and visible to the viewer when a digital advertisement displays during the viewer's search using an online search tool, for example, using Dexknows.com. The marker can be implemented in various ways. For example one implantation of a marker can entail a little triangle in the right upper corner of an ad, that has the appearance when displayed as that of a folded dog ear of a paper page, and the triangular area can have a fill color varying from white/grayish for small budget advertiser and yellow for large budget advertisers. In addition, when a viewer hovers the mouse pointer over the triangular area, a help text can be provided and displayed within the activated area of the triangle or as a separate pop up with an explanation and/or graphic representative of advertisement spend. Various other implementations of a marker can also be provided, for example,—a marker digitally displayed as a full/empty progressively shaded bar similar to review star ratings, but indicates if an advertiser spend is a large dollar amount or a small dollar amount;—a marker displayed as a shape, for example in the form of a small circle, that's added to the listing and color filled from light for a small dollar amount spend, to dark for a large dollar amount spend;—a marker displayed as a border around the listing, of varying depth; or—a marker displayed as a background color varying, for example, from light yellow to dark yellow. The marker could also be limited to the UI element itself, where the UI element depicts the graphical artistry.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is an implementation of a system for providing a marker indicative of online digital advertising spend;

FIG. 2 is a flow diagram of the user interface process;

FIG. 3 is a flow diagram illustrating a method for displaying a marker indicative of online digital advertising spend; and

FIGS. 4-5 are illustrations of screen shots displaying a marker.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

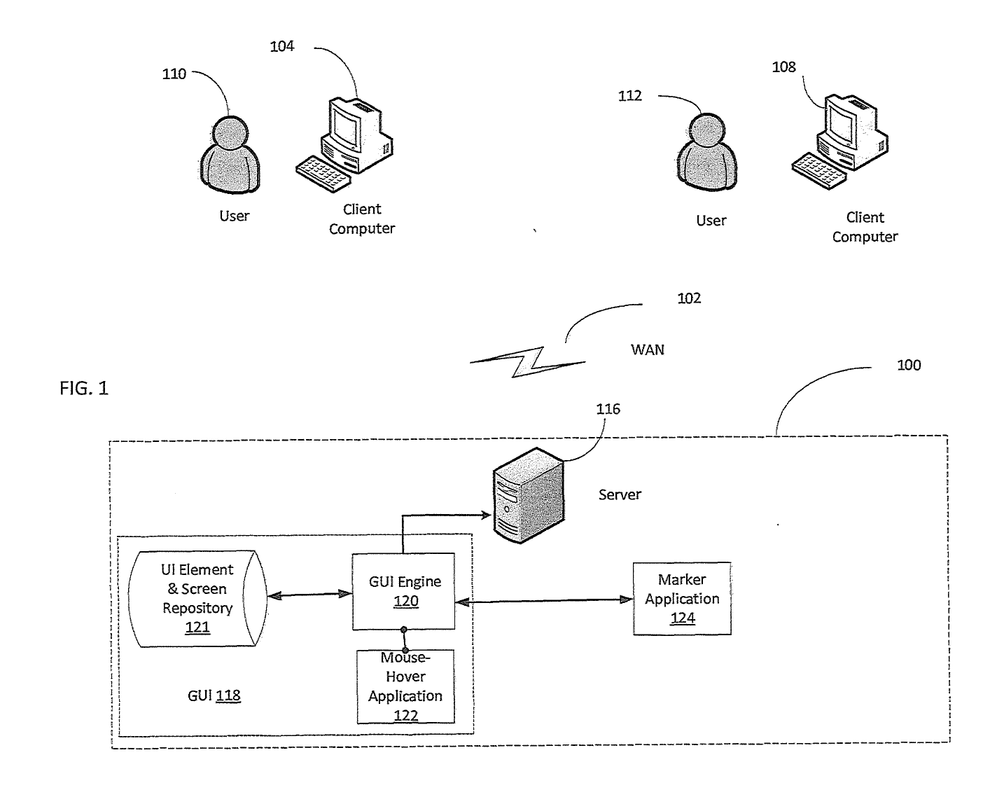

According to the embodiment(s) of the present invention, various views are illustrated in FIGS. 1-5 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising digitally displaying a marker indicative of an advertiser's spend for an online digital advertisement, which teaches a novel apparatus and method for providing a viewer of an online digital advertisement with an indicator providing insight into the advertiser's spend for digital advertisement.

Digital online advertisement is a form of promotion that uses the Internet and World Wide Web to deliver marketing messages to attract customers. Examples of online advertising include contextual ads on search engine results pages, banner ads, blogs, rich media Ads, social network advertising, interstitial ads, online classified advertising, advertising networks and e-mail marketing, including e-mail spam. Many of these types of ads are delivered by an ad server. One major benefit of online advertising is the immediate publishing of information and content that is not limited by geography or time. To that end, the emerging area of interactive advertising presents fresh challenges for advertisers. Advertisers must decide how to most cost effectively get exposure using digital online advertising. For example it may not be practical for an advertiser to have an ad campaign whereby they pay for a key word or term such that each time the key word or term is entered into an online search engine, their ad appears. The advertiser may only want to do this at certain times of day or certain days of the week. In this environment the advertiser can be selective as to when the digital ad is posted, for example, only in the morning on Mondays.

Therefore, the viewer (the user of an online tool such as a search engine) cannot discern whether the ad consistently displays or whether the ad only displays on certain occasions or only under certain conditions. Therefore the viewer does not have the capability to discern how much the advertiser has invested for the ad campaign. The more savvy viewer realizes the appearance of a prominent add at any given time is not a direct reflection on how much the advertiser has invested, therefore no impression of credibility of the advertiser is attached to the mere appearance of the ad. Even a less savvy viewer may ignore the ad as a mere annoyance. The technology as disclosed and claimed herein provides the more savvy viewer with pertinent information regarding the advertisers investment, thus an impression of credibility can be attached to the advertiser, similar to that of an ad listed in a paper copy directory.

In addition to the basic spend for the ad campaign, digital online advertising can have a further cost (revenue stream) and can be based on various cost models including cost-per-impression where advertisers pay for exposure of their message by volume and audience; cost-per-view where advertisers pay each time the ad is displayed; cost-per-click where the advertiser pays each time a user clicks on their ad or listing and is redirected to the advertiser's website.

In one implementation of the technology disclosed and claimed herein, advertiser spend data can be utilized. Advertiser spend data can be captured and the data can be electronically stored in a computer readable format for later retrieval and processing. The campaign spend data can be summed and stored as one grand total or the data can be stored as smaller subparts of the spend. Once the advertisement spend is determined, a numeric data field can be stored representative of the advertisement spend. Each data field stored can be correlated to a particular advertiser by way of an associated index field containing an advertiser's unique identifier or a form of a relational data lookup can be utilized.

The various data fields from the various advertisers can be used to establish a relative scale from the highest spend to the lowest. The data for the advertisement spend can be used to determine how the advertisement spend is to be graphically illustrated. The graphical illustration of the advertisement spend can be constructed real time or the graphical illustration can be pre-constructed. The graphical illustration can be constructed as a UI element. The UI element attributes and frameworks can be constructed that defines the appearance, functional behavior, format, data type, shape, dimension and syntax rule. For example, a UI element such as an icon can have associated attributes and frameworks that control the position of the icon on a display, the size of the icon, and the active area borders, sometimes referred to as boundary, dimensions and shape for interaction with for example a mouse pointer. The attributes and frameworks can also contain functional rules for example dictating when an interaction can occur, e.g. only display a UI element tool when a mouse pointer is positioned within an activated area. When an advertiser's ad is displayed the data representative of the advertisement spend can be retrieved and a representative graphical representation can be presented.

Various graphical presentations can be used including, drop down menus, pop-up menus, hover menus, tooltips, infotips and similar solutions which are User Interface (UI) element tools that are frequently used for online user interfaces. These UI element tools can be activated and used in conjunction with the functionality of a mouse pointer, where a UI element tool, for example a tooltip, is activated and displayed when the user clicks on a UI element, for example an icon, or hovers the mouse pointer over an icon's active area, for example, an active area of an icon, a button or other like display elements, generally referred to as a UI element. In the case of the technology disclosed and claimed herein, the marker can include a UI Element associated with advertisement spend data and/or a UI element tool associated with the UI element and/or advertisement spend data.

The UI element and/or the UI element tool when displayed typically provides an activated area having a defined boundary, which is an html image map on the user interface having functional attributes such that the image map has areas that are clickable, sometimes referred to as “selectable”, by a user or the activated area can simply display a message, for example, a pop-up balloon. The activated UI element tool typically disappears once the user stops hovering the mouse pointer over the activated area of the UI element and/or the UI Element tool, which can be referred to as a “mouse leave event”. For example, the mouse pointer can be navigated to a point outside an image map, which can be referred to as an activated mouse-over area, encompassing the UI element, for example, an icon, and the activated UI element tool itself.

The UI elements and UI element tools can have certain attributes associated with it and certain data associated with it. In the case of a UI element tool that is a pop-up message, the UI element tool can have data associated with the tool and a data field that can be populated with data illustrated as an alphanumeric or other graphical representation of the data and/or the UI element can have associated data and a data field that can be populated and presented by way of a data binding function. In the case of the technology described and claimed herein, the associated data can relate to a campaign ad spend and a UI element tool can be utilized to provide visibility and access to the data.

The details of the invention and various embodiments can be better understood by referring to the figures of the drawing. Referring to FIG. 1, a computer system 100 for implementation of the computer implemented method for providing a UI element as a marker with an online digital advertisement indicative of advertisement spend is shown. The computer system can have a server 116 for receiving information and transmitting information over a wide area network such as for example the internet. The computer system can have a server and a computer having a memory and one or more processors. Components of the computer system as shown can be combined or separated into its multiple sub-components as needed. The computer system can include a UI element and screen repository including all UI element attributes and screen attributes and frameworks that define their appearance, functional behavior, format, data type, shape, dimension and syntax rule. For example, a UI element such as an icon can have associated attributes and frameworks that control the position of the icon on a display, the size of the icon, and the active area borders, sometimes referred to as boundary, dimensions and shape for interaction with for example a mouse pointer. The attributes and frameworks can also contain functional rules for example dictating when an interaction can occur, e.g. only display a UI element tool when a mouse pointer is positioned within an activated area.

A graphical user interface (GUI) can include various windows, sometimes referred to as “screens”, having a defined layout where information can be displayed including various UI elements, such as buttons, icons, and UI element tools such as pull down menus, various other tools and the like. UI elements such as buttons can be displayed as a graphical image on a display device and the buttons can have an activated area encompassing the button such that when a user navigates a mouse pointer to a position on the display over the button, the mouse and the corresponding mouse pointer being displayed can be used as an interaction element to trigger other display events by interacting with other interaction elements, such as UI elements, for example, buttons, icons and the like, whereby the display event occurs such as displaying a UI element tool, for example a tooltip, which can also have an activated area. A user can click the mouse while the mouse pointer is positioned over the activated area of the button or simply hover the mouse over the activated area of the button. When the click or hover occurs, a UI element tool such as a tooltip can be displayed. The UI elements, for example, buttons, icons and the like, and the UI element tools, for example, tooltips, info-tips, drop-down menus and the like, are affordances showing places where a user can interact. An affordance can be defined as the quality of the UI element or UI element tool object and a definition of what actions can be performed when interacting with the object.

The graphical user interface engine module 120 can retrieve the appropriate screen and populate the screen with the necessary UI elements. The UI elements can include for example icons, buttons and the like, that can be selected by the user by positioning the mouse pointer over the icon and clicking with the mouse button or the user can simply hover the mouse pointer over the icon for selection. The mouse-over application 122 can interpret mouse positional navigation with respect to the screen and interpret any inputs from the mouse, for example clicks, hovering and mouse navigation. The position of the mouse can be tracked by the mouse-over application in various ways, including, for example, the navigational position of the mouse pointer can be interpreted in x,y coordinates with respect to the upper left corner of the screen.

The computer system 100 can include one or more programs, stored in the memory and executed by the one or more processors, where the one or more programs can include various instructions for performing various tasks. The computer system 100 and the Server 116 can have a memory where certain data is stored that can be associated with the UI elements and the UI element tool. A data binding module can be utilized to bind the data to the element and populate any data field of graphic field to be populated. The computer system 100 can communicate with other computing devices 104 and 108 over the WAN 102. Users 110 and 112 can navigate the mouse and can hover the mouse pointer over various UI elements and their various UI element tools that are provided indicative of selection.

User interface instructions can be processed by the processor of the computer 100 to generate a user interface for displaying on a display device of client computers 104 and 108. The graphical user interface 120 can execute UI element instructions for generating a computer generated UI element for a user interface and for generating a UI element activated area associated with and encompassing the UI element. The GUI can also execute UI element tool instructions for generating a computer generated UI element tool responsive to receiving a selection of the UI element and for generating a UI element tool initial activated area associated with and for encompassing the UI element tool and/or the UI element. The computing system 100 can receive and process the various mouse navigation and mouse inputs, for example hovering over an active area or pointing and clicking within an activated area of a UI element. The marker application 124 can execute marker instructions for generating a marker UI element and providing the marker for displaying on an online digital advertisement being displayed on a client computer. If a user at the client computer hovers over or clicks on the marker, an input can be provided and the computer system 100 can receive and interpret that input and can generate a UI element tool that displays the online advertisement spend and/or the can simple generate a graphic associated within the UI element. The marker application can for example reside encoded in CSS, JavaScript or HTML5 files associated with an online application's user interface controls.

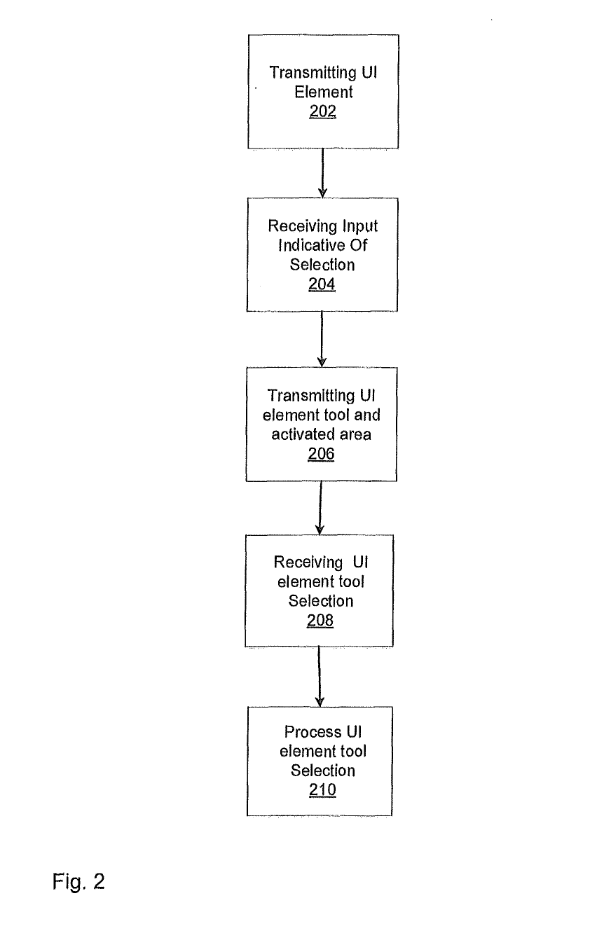

Referring to FIG. 2, a flow diagram of the user interface process is shown. The computer system can transmit a UI element 202 to a client computer for displaying the UI element within the online digital advertisement. For example, the UI element 202 can be a marker that visually provides the appearance of being a folded down “dog-ear” of a page. The folded back area can simply have a variation in shade or color as an indicator of advertisement spend. When a user hovers a mouse pointer over the active area of the UI element, the computer system can receive an input indicative of a selection 204 of the UI element. Responsive to the selection of the UI element the computer system can transmit a UI element tool and activated area 206 for displaying on a client computer. The UI element tool can be a pop-up with content graphically illustrating the advertisement spend. If the user continues to hover the mouse pointer over the UI element tool or selects by clicking, then the computer system can receive an input 208 indicative of the UI element tool selection. The computer system can process this selection and provide more information as requested.

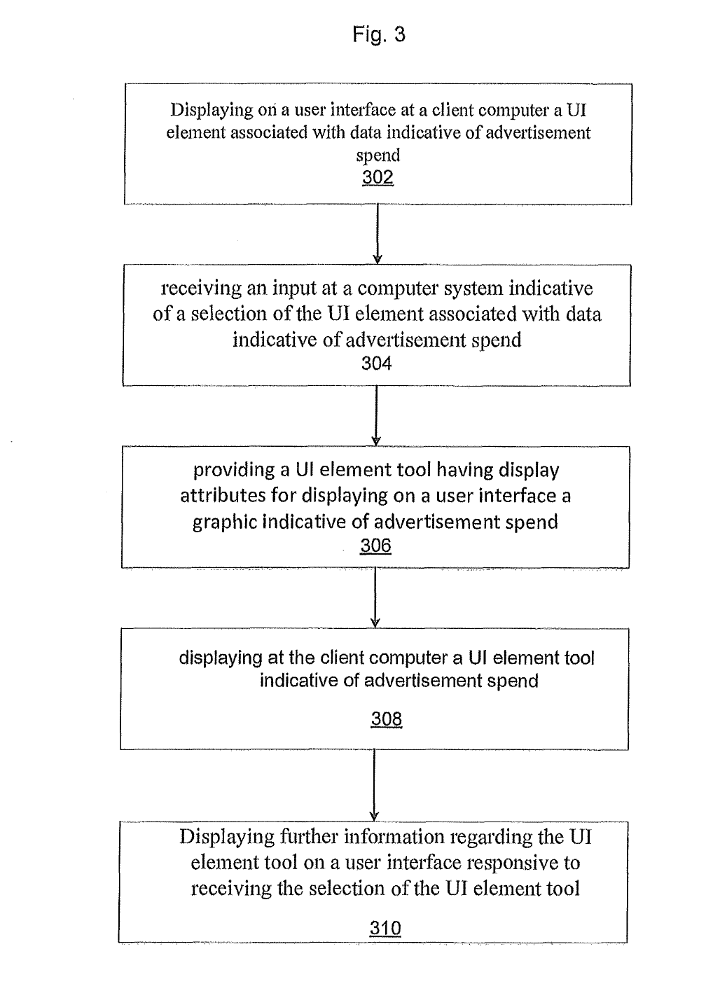

Referring to FIG. 3, a flow diagram illustrating a method for displaying a marker indicative of online digital advertising spend is shown. The method can include displaying on a user interface at a client computer 302 a UI element associated with data indicative of advertisement spend. A computer system can receive an input indicative of a selection 304 of the UI element, which is associated with data indicative of advertisement spend. The computer system can provide a UI element tool 306 having display attributes for displaying on a user interface a graphic indicative of advertisement spend. The UI element tool can be displayed 308 on the client computer on the user interface indicative of advertisement spend. Further information can be displayed regarding the tool or the graphic provided responsive to continuing to hover over the tool or clicking the tool.

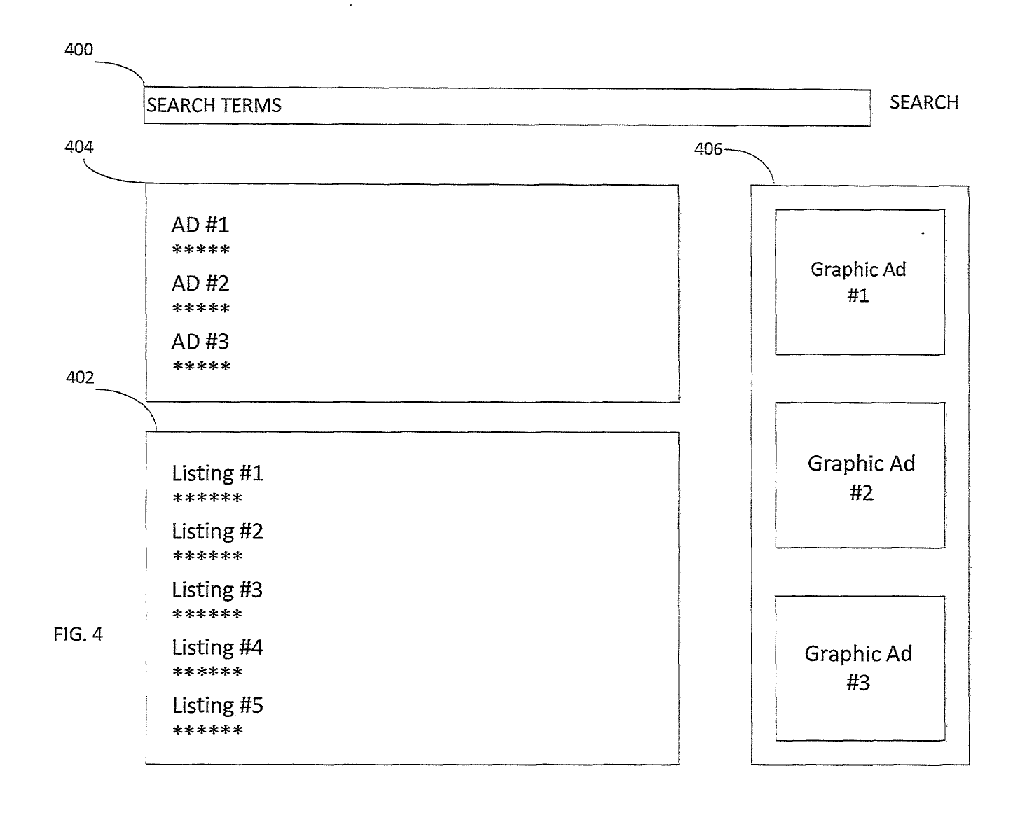

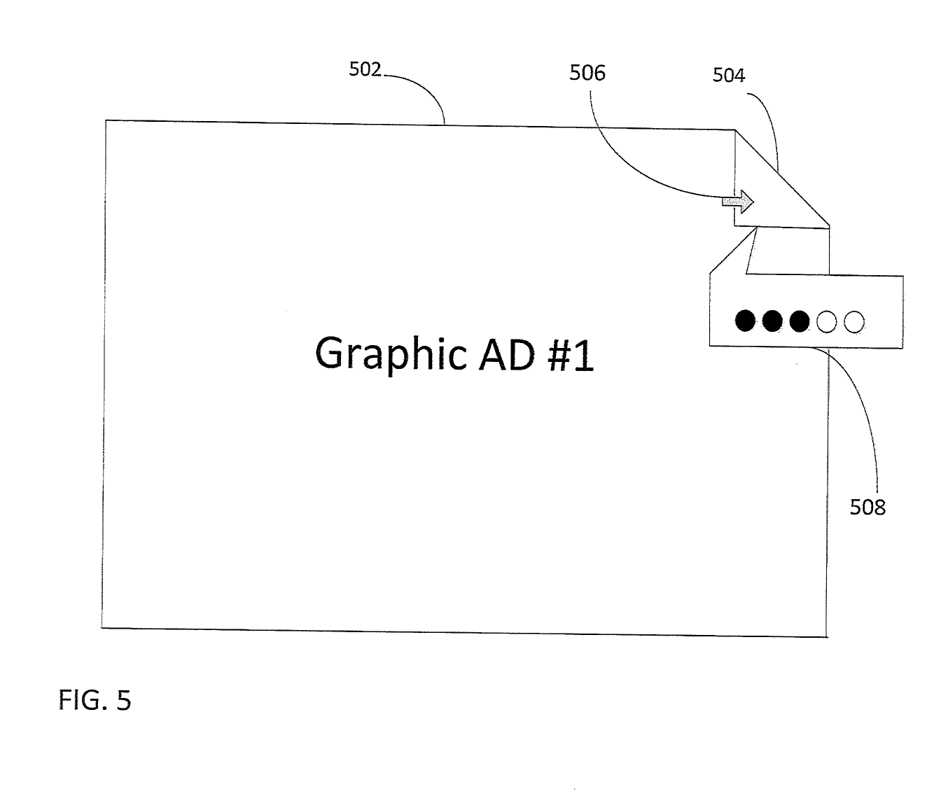

Referring to FIGS. 4-5 illustrations of screen shots displaying a marker are shown. FIG. 4 illustrates a typical layout of a search screen on a user interface with a search box 402. A user can enter a search term and select search and the search engine can return a listing of search results 402. A special window 404 can be added to highlight certain ads for a higher advertisement spend. The order of the listing may be a least partially driven by the advertisement spend amount. The special placement of the graphic ads 406 also results from a higher advertisement spend. FIG. 5, illustrates a Graphic ad that has a dog-eared corner, which is a marker 504. The marker can simply have a color coding or shading that is indicative of advertiser spend. When a user hovers a mouse pointer 506 over the marker 504, then the UI element tool 508 is displayed with a graphic illustrating advertisement spend. The implementation illustrated in FIG. 5 uses five circles as a rating for advertisement spend. The more circles that are filled, the higher the advertiser spend. The dog-eared corner can also have varying shades or colorations that also provide a graphic representative of advertisement spend. Without departing from the scope of the technology as disclosed and claimed herein, various other UI element types can be utilized as a marker and the technology can be used with online sites beyond search engine sites.

One embodiment of a graphical illustration of advertisement spend is varying the shading from transparent to light to dark or low contrast to high contrast for a defined display area, for example within the area of the dog ear. The lighter the shading or contrast correlates to a lesser advertisement spend. The shading could be a gray shading or a color hue shading. A given advertiser can be ranked among other peer advertisers from highest to lowest based on advertisement spend and the overall ranking of advertisers can be divided into percentiles such that each advertiser will fall within a given percentile. Each discrete percentile, for example the lowest 25% percentile, can be correlated to a given shade, and the highest 25% percentile can be correlated to a darker shade.

Another implementation could be to use some form of illustrating a direct specific scale, for example providing an illustration that an advertiser has a specific dollar spend, or percent of a maximum spend or a specific ranking among a total number of peer advertisers. Another implementation could include defining an independent scale, for example a $100 to $500 monthly spend is low, a $501 spend to a $750 monthly spend is medium, and a $751 spend to a $1000 monthly spend is high. An advertisers spend can be compared to the independent scale and assigned a low, medium or high and the assignment can be illustrated graphically by one of various different ways as described herein.

In one implementation an advertisement spend can be determined once an advertiser's monthly spend budget is determined. In another implementation, the advertisement spend for the implementation described herein can be simply the monthly spend (actual realized monetization), or a quarterly spend or annualized spend or any other one of multiple variations. In one implementation there can be one advertiser spend budget for each advertiser, which can be spent on any number of campaigns and with any number of publishers. However, the whole budget is utilized for determining the scale, even though only a portion is spent online where the viewers of the ads would have the ability to view the indicators. In addition, in one implementation the methodology could even consider the Print budget in the total spend, which is ultimately graphically represented as the total advertising investment that as known by a particular consulting agent, and not just the online digital portion.

Once the advertisement spend is determined, a numeric data field can be stored representative of the advertiser spend. That data can typically already be stored in some account management system/order management system/accounting system. The data can be retrieved from the account management system and stored locally for calculations. Each locally stored data field can be correlated to a particular advertiser by way of an associated index field containing an advertiser's unique identifier or a form of a relational data lookup. An advertisement can be assigned a ranking among other peer advertisers using the value of the advertiser spend through a comparative process, or a percentile can be determined calculated, or the value can be compared against an independent scale. The data can be simply representative of dollars or it can be representative of dollars translated into credits. If the amount of the advertisement spend is based on the monthly advertiser spend budget, then the graphical illustration for that advertiser would remain the same within a given month having that spend unless the spend budget is adjusted. The data can be handled and manipulated in various different ways that are well known in the art.

The various online marker examples shown above illustrate a system and method for providing a viewer of an online digital advertisement with an indicator providing insight into the advertiser's spend for digital advertisement. A user of the present invention may choose any of the above implementations, or an equivalent thereof, depending upon the desired application. In this regard, it is recognized that various forms of the subject online marker could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

The various implementations and examples shown above illustrate a method and system for online markers indicative of an advertiser's advertisement spend. A user of the present method and system may choose any of the above implementations, or an equivalent thereof, depending upon the desired application. In this regard, it is recognized that various forms of the subject online marker method and system could be utilized without departing from the spirit and scope of the present implementation.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system 100 and client computers 104 and 108 can include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system 100 and client computing devices 104 and 108 also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

Other aspects, objects and advantages of the present invention can be obtained from a study of the drawings, the disclosure and the appended claims.

What is claimed is:

1. A computer implemented method for providing a UI element as a marker with an online digital advertisement indicative of advertisement spend comprising the steps of:
receiving at a computer system an input indicative of a selection of a UI element associated with data indicative of advertisement spend; and
providing a UI element tool having display attributes for displaying on a user interface an activated area associated with the UI element tool responsive to receiving the selection of the UI element and where the activated area presents a graphic indicative of advertisement spend.

2. The computer implemented method as recited in claim 1, where the graphic indicative of advertisement spend includes a row of individual geometric shapes progressively shaded based on the data indicative of advertisement spend.

3. The computer implemented method as recited in claim 1, where the graphic indicative of advertisement spend includes a single geometric shape having a progressively darkened color based on the data indicative of advertisement spend.

4. The computer implemented method as recited in claim 1, where the data indicative of advertisement spend includes the sum of all online advertisement spend and paper copy advertisement spend.

5. The computer implemented method as recited in claim 1, where the graphic indicative of advertisement spend is a direct specific scale.

6. A computer implemented method for providing a UI element as a marker with an online digital advertisement indicative of advertisement spend comprising the steps of:
displaying on a user interface at a computer system a UI element associated with data indicative of advertisement spend;
receiving an input at the computer system indicative of a selection of the UI element associated with data indicative of advertisement spend; and
displaying a UI element tool on a user interface having an activated area associated with the UI element tool responsive to receiving the selection of the UI element and where the activated area presents a graphic indicative of advertisement spend.

7. The computer implemented method as recited in claim 6, where the graphic indicative of advertisement spend includes a row of individual geometric shapes progressively shaded based on the data indicative of advertisement spend.

8. The computer implemented method as recited in claim 6, where the graphic indicative of advertisement spend includes a single geometric shape having a progressively darkened color based on the data indicative of advertisement spend.

9. The computer implemented method as recited in claim 6, where the data indicative of advertisement spend includes the sum of all online advertisement spend and paper copy advertisement spend.

10. The computer implemented method as recited in claim 6, where the graphic indicative of advertisement spend is a direct specific scale.

11. A computer system for controlling a UI element as a marker with an online digital advertisement indicative of advertisement spend comprising:
a computer having a memory and one or more processors;
one or more programs, stored in the memory and executed by the one or more processors, where the one or more programs include,
instructions for receiving at a computer system an input indicative of a selection of a UI element associated with data indicative of advertisement spend; and
instructions for providing a UI element tool having display attributes for displaying on a user interface an activated area associated with the UI element tool responsive to receiving the selection of the UI element and where the activated area presents a graphic indicative of advertisement spend.

12. The computer system as recited in claim 11, where the one or more programs include, instructions for providing the UI element associated with data indicative of advertisement spend for displaying on a user interface along with an advertisement that is being displayed.

13. The computer system as recited in claim 12, where the one or more programs include, instructions for providing the UI element having display attributes for displaying on a user where the UI element includes a graphic indicative of advertisement spend.

14. The computer system as recited in claim 13, where the one or more programs include, instructions for providing a graphical area of the UI element having varying shading based upon and indicative of advertisement spend.

15. The computer system as recited in claim 11, where the one or more programs include, instructions for providing the graphic indicative of advertisement spend including a row of individual geometric shapes progressively shaded based on the data indicative of advertisement spend.

16. A computer system for controlling an activated mouse-over area of a user interface comprising:
a computer having a memory and one or more processors;
one or more programs, stored in the memory and executed by the one or more processors, where the one or more programs include,
instructions for displaying on a user interface at a computer system a UI element associated with data indicative of advertisement spend;
instructions for receiving an input at the computer system indicative of a selection of the UI element associated with data indicative of advertisement spend; and
instructions for displaying a UI element tool on a user interface having an activated area associated with the UI element tool responsive to receiving the selection of the UI element and where the activated area presents a graphic indicative of advertisement spend.

17. The computer system as recited in claim 16, where the one or more programs include, instructions for providing the graphic indicative of advertisement spend including a row of individual geometric shapes progressively shaded based on the data indicative of advertisement spend.

18. The computer system as recited in claim 16, where the one or more programs include, instructions for providing the graphic indicative of advertisement spend including a single geometric shape having a progressively darkened color based on the data indicative of advertisement spend.

19. The computer system as recited in claim 16, where the one or more programs include, instructions for providing a graphical area of the UI element having varying shading based upon and indicative of advertisement spend.

20. The computer system as recited in claim 16, where the one or more programs include, instructions for receiving and summing all online advertisement spend and paper copy advertisement spend into a sum of all online advertisement spend and paper copy advertisement spend.

21. A non-transitory computer readable storage medium for use in conjunction with a computer system, the computer readable storage medium storing one or more programs including instructions for execution by the computer system, the one or more programs when executed by the computer system cause the computer system to perform operations comprising:
receiving at a computer system an input indicative of a selection of a UI element associated with data indicative of advertisement spend; and
providing a UI element tool having display attributes for displaying on a user interface an activated area associated with the UI element tool responsive to receiving the selection of the UI element and where the activated area presents a graphic indicative of advertisement spend.

22. The non-transitory computer readable storage medium as recited in claim 21, where the graphic indicative of advertisement spend includes a row of individual geometric shapes progressively shaded based on the data indicative of advertisement spend.

23. The non-transitory computer readable storage medium as recited in claim 21, where the graphic indicative of advertisement spend includes a single geometric shape having a progressively darkened color based on the data indicative of advertisement spend.

24. The non-transitory computer readable storage medium as recited in claim 21, where the data indicative of advertisement spend includes the sum of all online advertisement spend and paper copy advertisement spend.

25. The non-transitory computer readable storage medium as recited in claim 21, where the graphic indicative of advertisement spend is a direct specific scale.

26. A non-transitory computer readable storage medium for use in conjunction with a computer system, the computer readable storage medium storing one or more programs including instructions for execution by the computer system, the one or more programs when executed by the computer system cause the computer system to perform operations comprising:
displaying on a user interface at a computer system a UI element associated with data indicative of advertisement spend;
receiving an input at the computer system indicative of a selection of the UI element associated with data indicative of advertisement spend; and
displaying a UI element tool on a user interface having an activated area associated with the UI element tool responsive to receiving the selection of the UI element and where the activated area presents a graphic indicative of advertisement spend.

27. The non-transitory computer readable storage medium, as recited in claim 26, where the graphic indicative of advertisement spend includes a row of individual geometric shapes progressively shaded based on the data indicative of advertisement spend.

28. The non-transitory computer readable storage medium, as recited in claim 26, where the graphic indicative of advertisement spend includes a single geometric shape having a progressively darkened color based on the data indicative of advertisement spend.

29. The non-transitory computer readable storage medium, as recited in claim 26, where the data indicative of advertisement spend includes the sum of all online advertisement spend and paper copy advertisement spend.

30. The non-transitory computer readable storage medium, as recited in claim 26, where the graphic indicative of advertisement spend is a direct specific scale.

31. A computer implemented method for providing a UI element as a marker with an online digital advertisement indicative of advertisement spend comprising the steps of:
receiving at a computer system a query input indicative of a viewer query initiated at a user interface;
providing data for a graphical representation of an advertisement responsive to the viewer query for displaying on the user interface;
receiving a selection input indicative of a selection of a UI element associated with data indicative of advertisement spend; and
providing the UI element having display attributes for displaying on a user interface where the UI element includes a graphic indicative of advertisement spend.

32. The computer implemented method as recited in claim 31, where the graphic indicative of advertisement spend includes a row of individual geometric shapes progressively shaded based on the data indicative of advertisement spend.

33. The computer implemented method as recited in claim 31, where the graphic indicative of advertisement spend includes a single geometric shape having a progressively darkened color based on the data indicative of advertisement spend.

34. The computer implemented method as recited in claim 31, where the data indicative of advertisement spend includes the sum of all online advertisement spend and paper copy advertisement spend.

35. The computer implemented method as recited in claim 31, where the graphic indicative of advertisement spend is a direct specific scale.
